(19) United States
(12) Patent Application Publication
(10) Pub. No.: US 2017/0341907 A1
(43) Pub. Date: Nov. 30, 2017

(54) ELECTRICAL ENERGY GENERATION WITHIN AN ELEVATOR INSTALLATION

(71) Applicant: Inventio AG, Hergiswil (CH)

(72) Inventor: Henrique Ferreira, Sao Paulo (BR)

(73) Assignee: Inventio AG, Hergiswil (CH)

(21) Appl. No.: 15/535,539

(22) PCT Filed: Dec. 14, 2015
(86) PCT No.: PCT/EP2015/079598

§ 371 Date: Jun. 13, 2017

(30) Foreign Application Priority Data
Dec. 18, 2014 (EP) 14198952.5

(51) Int. Cl. B66B 7/06; D07B 1/14; D07B 1/22

(52) U.S. Cl. CPC B66B 7/062; D07B 1/147; D07B 2501/2007; D07B 1/22

(57) ABSTRACT

An elevator installation and method to passively and reliably generate electrical energy while an elevator installation is in operation includes an elevator car, a tension member for supporting and moving the elevator car, and a pulley engaging with the tension member. Piezoelectric elements are applied to or embedded within the tension member. As the tension member is driven to move the elevator car up and down along an elevator hoistway, the tension member also engages with the rotating pulley. Force imparted to the tension member during this engagement with the pulley is transmitted to the piezoelectric elements which consequently generate electrical energy.

### FIELD

The present invention relates to elevator installations and particularly to the passive generation of electrical energy while such an elevator installation is in operation.

### BACKGROUND

The use of piezoelectric elements has been proposed previously within the field of elevators to generate control signals, which are fed to an elevator controller enabling the controller to regulate operation of the elevator. For example, JP-A-2002068618 and U.S. Pat. No. 6,715,587 B2 both describe the use of piezoelectric elements mounted either between or to one of an elevator car and its associated frame. The piezoelectric elements in these examples are provided as pressure sensors, which generate signals to an elevator controller enabling the controller to determine changes in the load within an elevator car. EP-A1-1700810 and DE-B3-102012108036 likewise describe the use of a piezoresistive element as a pressure sensor to determine the tension in a support means of a conveyor.

EP-A1-1780159 and EP-A2-0636569 describe elevator operating panels, which are generally provided on each landing to enable prospective passengers waiting on the landing to call an elevator. Similar panels may also be mounted within the elevator car to allow boarded passengers to enter their required destination floor. In both the arrangements, piezoelectric elements are used within the operating panels as buttons such that upon exertion of sufficient pressure by a passenger's finger, the elements generate the required signal to the elevator controller and can also illuminate an LED to indicate acceptance of the passenger's call.

Accordingly, piezoelectric elements have been used within elevators to generate control signals either for determining the changes in the load within an elevator car or acting as call signals for transmission to the elevator controller.

However, since load changes within the elevator car occur rather intermittently and buttons on the operating panel have a small cross-sectional area and can be operated with relatively little pressure, neither of these applications of piezoelectric elements within elevators is sufficient to generate a reliable supply of energy.

### SUMMARY

The present invention has been developed to overcome the above-identified problems related to the described prior art.

An objective of the present invention is to provide an elevator and method to passively and reliably generate electrical energy while an elevator installation is in operation.

The elevator installation comprises an elevator car, a tension member for supporting and moving the elevator car, a pulley engaging with the tension member wherein piezoelectric elements are applied to or embedded within the tension member, and a power storage unit having an input electrically connected to at least one anode and at least one cathode of the piezoelectric elements. Thereby electrical energy generated by the piezoelectric layer can be harvested in the power storage unit.

In use, although the tension exerted on the tension member by the loads within the elevator car is primarily absorbed by the tension member itself, some tension will inherently be transmitted to the piezoelectric elements. Accordingly, variations in the number of passengers and thereby the load of the elevator car will tend to stretch and contract the piezoelectric elements resulting in the generation of electrical energy.

Moreover, and more particularly, the tension member undergoes substantial compression each time it is deflected by any pulley along its travel path. Typically, the rated speed of pulleys within an elevator installation, and thereby that of the tension member they engage, is relatively high. Given this relative high speed and the substantial compressive force differentials exerted on the piezoelectric elements on or within the tension member during engagement with pulleys, a significant and reliable supply of electrical energy can be generated by the piezoelectric elements when the elevator is in operation.

Preferably, the piezoelectric elements are incorporated within a piezoelectric layer which can be formed on a surface of the tension member or embedded within the tension member. Such piezoelectric layers are readily available and for an existing tension member are easily applied to an outer surface. Alternatively, the piezoelectric elements can be embedded individually or in layer form during the manufacture of a new tension member.

The tension member can comprise at least one tensile carrier surrounded by a casing. In this example, the majority of the tension exerted on the member is transmitted through the tensile carrier. The casing can be formed of a suitable material to protect the tensile carrier from corrosion and other environmental conditions. The casing material may also be selected to enhance engagement with the pulley or reduce noise during such engagement. Typically, the tensile carrier is formed from steel and the casing is formed from a plastic such as polyurethane.

Energy generated can be transferred into an electrical energy bank within the power storage unit and can be stored for subsequent use. The electrical energy bank may comprise batteries, capacitors, fuel cells or any other form of DC electrical energy storage.

Depending on the respective voltage ratings of the piezoelectric elements and the electrical energy bank, it may be necessary to insert a DC to DC converter between the input of the power storage unit and the electrical energy bank.

Preferably, energy harvested within the power storage unit can be supplied to external electrical loads via one or more outputs. If the external load has the same voltage rating as the energy bank it can be supplied from a DC output connected directly to the energy bank. Alternatively, the voltage from the energy bank can be bucked, boosted or otherwise transformed by a DC to DC converter to supply external electrical loads having different voltage ratings via a further DC output. Furthermore, a DC to AC inverter can be used to invert the DC power from the energy bank into AC power, which can be supplied to external electrical loads via an AC output.

In a preferred embodiment the power storage unit is mounted to the elevator car. Accordingly, energy harvested can be used to supply electrical loads within the car and this enables at least a reduction in the rating of any travelling cable used to power the electrical loads within the car if not enabling the design engineer to dispose of the travelling cable completely.

The invention further provides a method for providing electrical energy within an elevator installation comprising the steps of providing a tension member to support and move an elevator car, providing a pulley for engagement with the tension member, applying piezoelectric elements to or embedding piezoelectric elements within the tension member, and electrically connecting the piezoelectric layer to a power storage unit.

Subsequently, the electrical energy harvested can be supplied from the power storage unit to an electrical load.

### DESCRIPTION OF THE DRAWINGS

By way of example only, preferred embodiments of the present invention will be described in detail with reference to the accompanying drawings, of which:

FIG. 1 is an exemplary schematic showing a conventional arrangement of components within an elevator installation according to the present invention;

FIGS. 2A-2C are cross-sectional views of alternative tension members according to exemplary embodiments suitable for use in the elevator installation of FIG. 1,

FIG. 3 is a perspective view of an end connection for connecting the tension member of FIG. 2B to the car of FIG. 1; and

FIG. 4 is a schematic of an exemplary embodiment of a power storage unit in which energy generated by the piezoelectric layer of FIGS. 2B and 3 is harvested.

### DETAILED DESCRIPTION

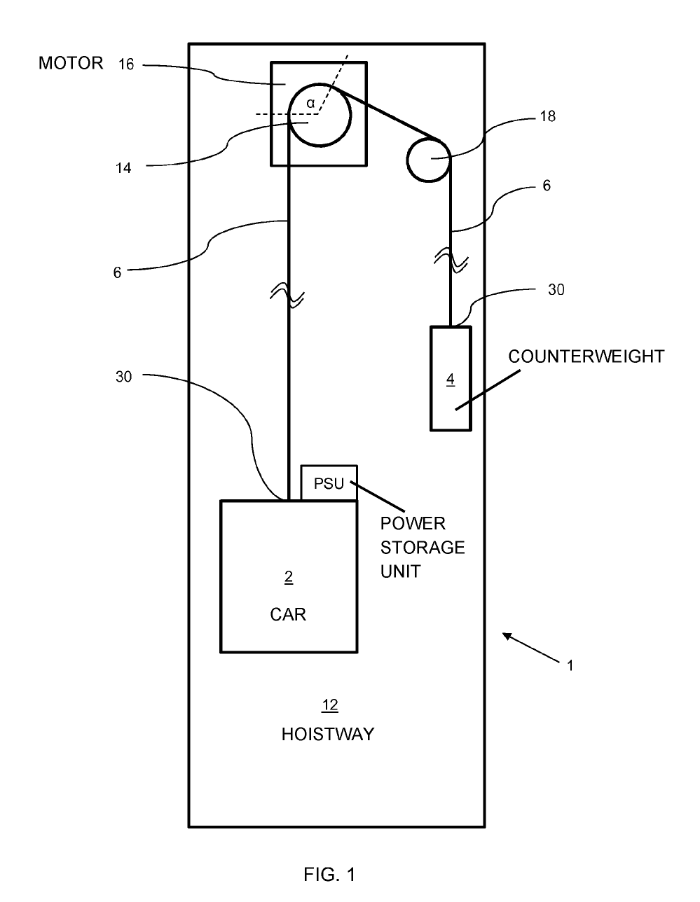

FIG. 1 illustrates an exemplary embodiment of a conventional arrangement of components within an elevator installation 1. An elevator car 2 and a counterweight 4 are supported on a traction member 6 within an elevator hoistway 12. In this example, the tension member 6 has a 1:1 roping ratio whereby it extends from an end connection 30 fixed to the car 2 up the hoistway 12 for engagement through a wrap angle α with a traction sheave 14 driven by a motor 16, over a deflection pulley 18 and subsequently back down the hoistway 12 to a further end connection 30 fixed to the counterweight 4. Naturally, the person skilled in the art will easily recognize that alternative roping arrangements are equally applicable and that the traction sheave 14 and its associated motor 16 can be mounted within the shaft 12 to provide what is conventionally known as a machine-room-less (MRL) installation, as shown, or alternatively can be provided in a separate and dedicated machine room.

In operation, as the traction sheave 14 is rotated by the motor 16, it engages with the traction member 6 to vertically move the car 2 and counterweight 4 in opposing directions along guiderails (not shown) within the hoistway 12.

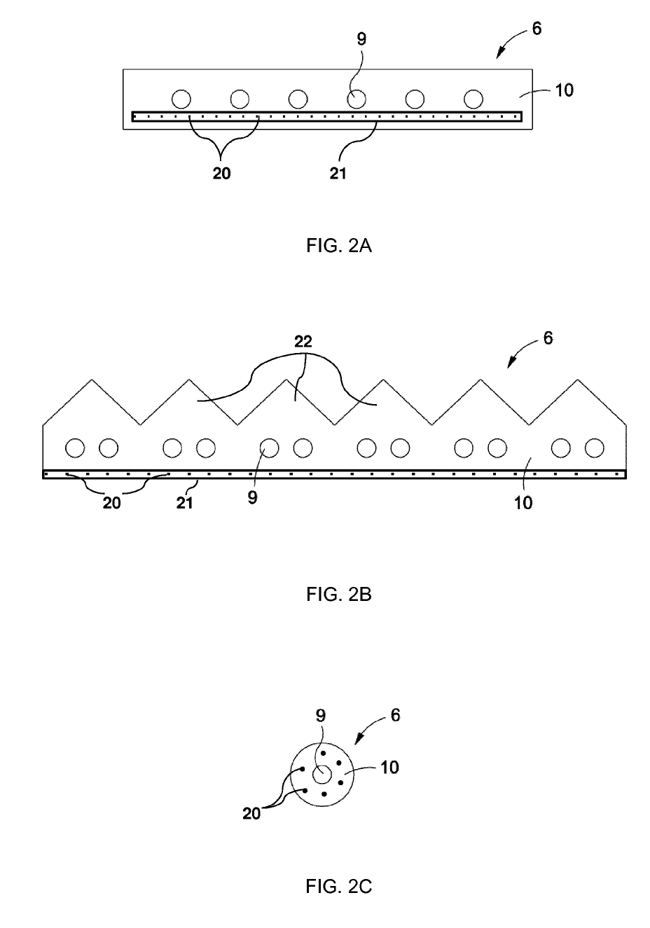

FIGS. 2A-2C are cross-sectional views of alternative tension members according to exemplary embodiments of the invention which are suitable for use in the elevator installation 1 of FIG. 1. In the example depicted in FIG. 2A, the tension member 6 is in the form of a flat belt having a plurality of tensile carriers 9 surrounded by a casing 10. A piezoelectric layer 21 incorporating a plurality of piezoelectric elements 20 is also embedded within the belt casing 10.

FIG. 2B shows an alternative arrangement wherein the casing 10 of the belt 6 no longer forms a flat surface but instead provided a plurality of V-shaped ribs 22. The engagement of these ribs 22 with corresponding grooves provided on the traction sheave 14 and deflection pulley 18 not only provides guidance of the belt 6 as it is driven by the traction sheave 14 to move the interconnected car 2 and counterweight 4 through the hoistway 12 but can also enhance the traction between the belt 6 and the traction sheave 14. Contrary to the previous embodiment, the piezoelectric layer 21 is provided on a flat exposed surface of the belt 6 opposite to the ribs 22.

FIG. 2C illustrates a further exemplary embodiment, wherein the tension member 6 is in the form of a round rope having one or more tensile carriers 9 surrounded by a casing 10. In addition to the tensile carriers 9, a plurality of piezoelectric elements 20 are also embedded within the casing 10.

Typically, the tensile carriers 9 will by formed of steel wires and the casing 10 can be formed from a plastics material such as polyurethane.

In use, although the tension exerted on the tension member 6 by the opposing loads of the elevator car 2 and counterweight 4, respectively, is primarily absorbed by the carriers 9 within the tension member 6, some tension will inherently be transmitted to the casing 10 and to the piezoelectric elements 20. Accordingly, variations in the number of passengers and thereby the load of the elevator car 2 will tend to stretch and contract the piezoelectric elements 20 resulting in the generation of electrical energy.

Moreover, and more particularly, the tension member 6 undergoes substantial compression each time it comes into traction engagement as it passes over the wrap angle α of the traction sheave 14 and additionally as it is deflected over any deflection pulleys 18 along its travel path.

The rated speed of a traction sheave 14, and thereby that of the tension member 6 it drives, will vary widely depending on application. Typical factors that are taken into consideration include sheave diameter, wrap angle α, rated load, travel height, roping ratio and tension member type. Consequently, the traction sheave 14 may have a rated speed ranging from the tens to the hundreds of revolutions per minute (rpm).

Given, firstly, the relatively high speed of the traction sheave 14 and therefore of the tension member 6, and secondly, the substantial compressive force differentials exerted on the piezoelectric elements 20 on or within the tension member 6 during engagement with the traction sheave 14 and deflection pulleys 18, a significant and reliable supply of electrical energy can be generated by the piezoelectric elements 20 when the elevator 1 is in operation.

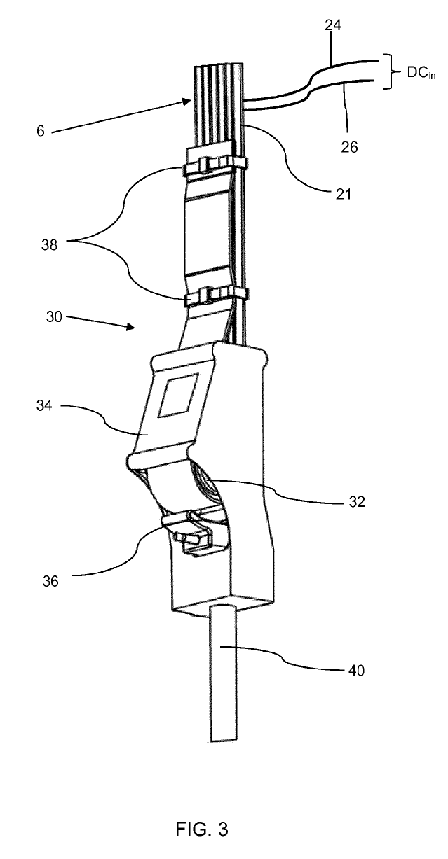

FIG. 3 is a perspective view of an end connection 30 for the connecting the tension member 6 of FIG. 2B to the elevator car 2 of FIG. 1. A free-end of the tension member 6 is looped over a wedge 32 which is subsequently inserted into a corresponding wedge socket 34 and held in place by a removable projection 36. The clamping forces acting on the tension member 6 by the wedge and socket ensures that, in operation, there is substantially no slippage of the tension member 6 out of the socket 34. An exposed section of the free-end of the tension member 6 is secured to the parallel incoming section of the tension member 6 by one or more clamps 38. The socket 34 is connected to the elevator car or frame thereof by one or more bolts 40.

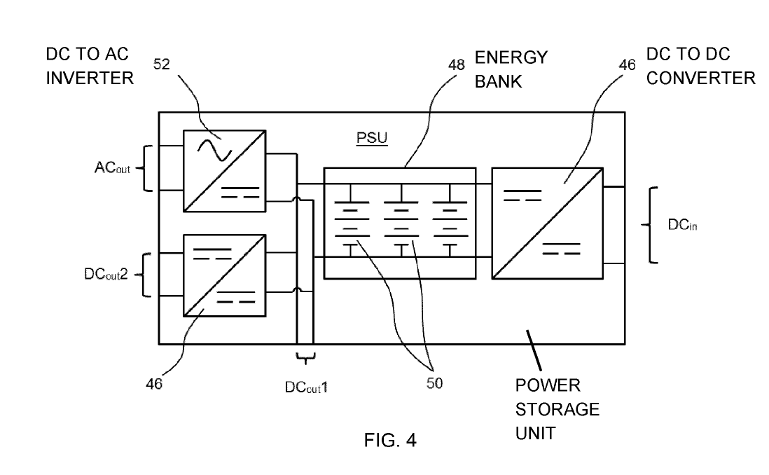

With respect to the piezoelectric layer 21 applied to the tension member 6, anode(s) and cathode(s) of the piezoelectric elements 20 are extracted therefrom and connected to a first insulated wire 24 and to a second insulated wire 26, respectively. The DC voltages supplied along these wires 24 and 26 are used as an input DCᵢₙ to the power storage unit PSU which is mounted on the elevator car 2 as shown in FIG. 1 and which will be further described with reference to FIG. 4.

Within the power storage unit PSU, the electrical energy from the input DCᵢₙ can be feed through a DC to DC converter 46 and is ultimately stored in an energy bank 48, which in this instance comprises a plurality of rechargeable batteries 50. Naturally other forms of DC electrical energy storage such as capacitors, fuel cells etc. are equally feasible.

Power harvested in the DC energy bank 48 can be fed directly to a first DC output DCₒᵤₜ1 and supplied further to electrical loads operating with the same voltage rating as the energy bank 48. Alternatively, the voltage from the energy bank 48 can be bucked, boosted or otherwise transformed by a further DC to DC converter 46 to supply external electrical loads having different voltage ratings via a second DC output DCₒᵤₜ2. Furthermore, a DC to AC inverter 52 can be used to invert the DC power from the energy bank 48 into AC power, which is supplied to external electrical loads via an AC output ACₒᵤₜ. Accordingly the power harvested within the power storage unit PSU can be supplied to electrical loads within the car 2 such as lighting, ventilation, operating panels etc.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. An elevator installation comprising:
an elevator car;
a tension member supporting and moving the elevator car, wherein a plurality of piezoelectric elements is applied to or embedded within the tension member;
a pulley engaging with the tension member; and
a power storage unit having an input electrically connected to at least one anode and at least one cathode of the piezoelectric elements for receiving electrical energy generated by the piezoelectric elements during operation of the elevator installation.

14. The elevator installation according to claim 13 wherein the piezoelectric elements are incorporated within a piezoelectric layer formed on a surface of the tension member.

15. The elevator installation according to claim 13 wherein the piezoelectric elements are incorporated within a piezoelectric layer embedded within the tension member.

16. The elevator installation according to claim 13 wherein the tension member is a belt.

17. The elevator installation according to claim 13 wherein the tension member includes at least one tensile carrier surrounded by a casing.

18. The elevator installation according to claim 13 wherein the power storage unit includes an electrical energy bank for storing the received electrical energy.

19. The elevator installation according to claim 18 wherein the power storage unit includes a DC to DC converter interconnecting the input and the electrical energy bank.

20. The elevator installation according to claim 18 wherein the power storage unit includes a DC output either directly connected to the electrical energy bank or connected through a DC to DC converter to the electrical energy bank.

21. The elevator installation according to claim 18 wherein the power storage unit includes a DC to AC rectifier interconnecting the electrical energy bank to an AC output.

22. The elevator installation according to claim 13 wherein the power storage unit is mounted to the elevator car.

23. A method for providing electrical energy within an elevator installation comprising the steps of:
providing a tension member to support and move an elevator car;
providing a pulley in engagement with the tension member;
applying piezoelectric elements to or embedding piezoelectric elements within the tension member; and
electrically connecting the piezoelectric elements to a power storage unit.

24. The method according to claim 23 further comprising the step of supplying electrical energy from the power storage unit to an electrical load.
